(19) United States
(12) Patent Application Publication
(10) Pub. No.: US 2010/0294751 A1
(43) Pub. Date: Nov. 25, 2010

(54) VARIABLE FREQUENCY HEATING CONTROLLER

(75) Inventors: Lance Chandler, Toutle, WA (US); Uy Duong Dieu Au, Vancouver, WA (US); Douglas Chandler, Allyn, WA (US)

Correspondence Address: Schwabe Williamson & Wyatt;PACWEST CENTER, SUITE 1900, 1211 SW FIFTH AVENUE, PORTLAND, OR, 97204, US

(73) Assignee: INNOVATIVE ENGINEERING & PRODUCT DEVELOPMENT, INC., Toutle, WA (US)

(21) Appl. No.: 12/471,120

(22) Filed: May 22, 2009

(51) Int. Cl. H05B 1/02; H05B 3/34

(52) U.S. Cl. 219/494; 219/482; 219/545

(57) ABSTRACT

Embodiments of the present disclosure provide methods, systems, and apparatuses related to maintaining a temperature of a target element. Some of the embodiments of the present disclosure provide an apparatus comprising a heating element configured to heat a target element, a temperature sensing device configured to provide an output proportional to a temperature of the heating element or the target element, and a controller configured to modulate an amplitude, duration and frequency of individual current pulses of a series of current pulses applied to the heating element, based at least in part on the output of the temperature sensing device. Other embodiments may be described and claimed.

### FIELD

Embodiments of the present disclosure relate to the field of heating, and more particularly, to variable frequency heating controllers.

### BACKGROUND

In many applications, it may be desirable to control a temperature of a device to follow a target temperature profile. The temperature of the device may be controlled by modulating current of one or more heating elements that are thermally coupled to the device. It may be desirable to control the temperature using minimal or reduced power.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1a illustrates an exemplary heating system, in accordance with various embodiments of the current disclosure;

FIG. 1b illustrates another exemplary heating system, in accordance with various embodiments of the current disclosure;

FIG. 2 illustrates an exemplary series of current pulses applied to heating elements of FIGS. 1a and 1b, in accordance with various embodiments of the current disclosure; and

FIG. 3 is an exemplary method for operating the heating systems of FIGS. 1a and 1b, in accordance with various embodiments of the current disclosure.

### DETAILED DESCRIPTION

In the following detailed description, reference is made to the accompanying drawings which form a part hereof wherein like numerals designate like parts throughout, and in which is shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

Various operations may be described as multiple discrete operations in turn, in a manner that may be helpful in understanding embodiments of the present disclosure; however, the order of description should not be construed to imply that these operations are order dependent.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Various components may be introduced and described in terms of an operation provided by the components. These components may include hardware, software, and/or firmware elements in order to provide the described operations. While some of these components may be shown with a level of specificity, e.g., providing discrete elements in a set arrangement, other embodiments may employ various modifications of elements/arrangements in order to provide the associated operations within the constraints/objectives of a particular embodiment.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

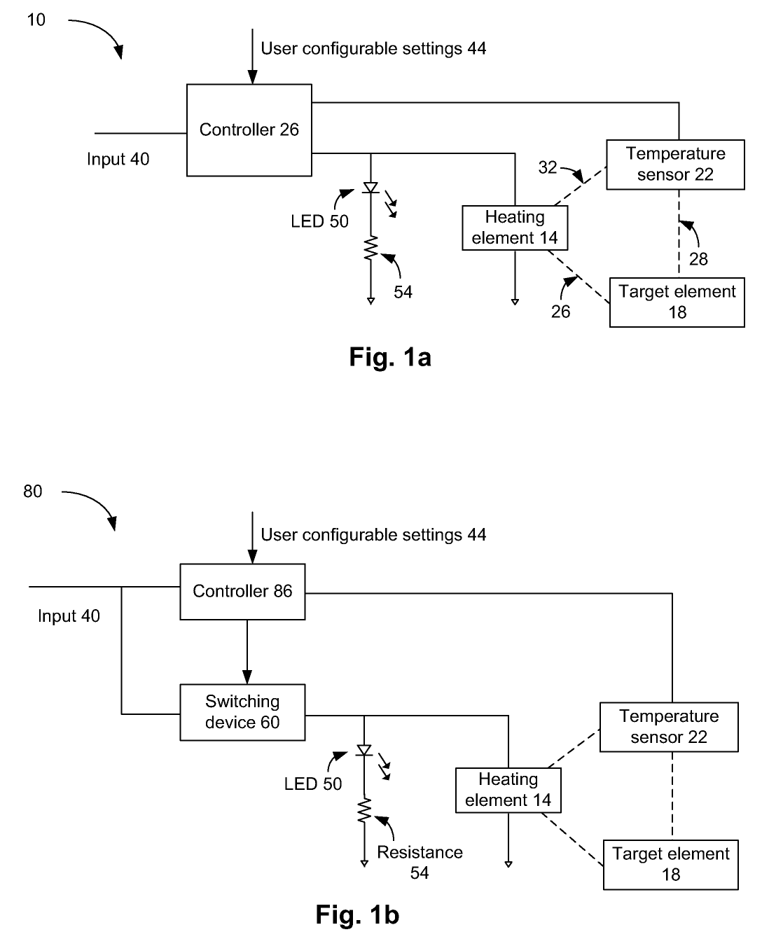

FIG. 1a illustrates an exemplary heating system 10, in accordance with various embodiments of the current disclosure. The heating system 10 may include a heating element 14 thermally coupled (illustrated by dotted line 26) to a target element 18. In various embodiments, the heating element 14 may be configured to control the temperature of the target element 18 by transferring heat from the heating element 14 to the target element 18. The heating element 14 may be, for example, a conductive thread, a metal wire or ribbon, or any other appropriate type of heating element known to those skilled in the art. The heating element 14 may be configured to generate heat energy in response to current passing through the heating element 14. The target element 18 may be any suitable element whose temperature is to be controlled, and may be, for example, a fabric, a garment (e.g., a thermal glove, a thermal blanket), a battery (e.g., whose temperature may need to be controlled for proper operation of the battery), or the like.

In various embodiments, the heating system 10 may also include a controller 26 configured to control the temperature of the heating element 14 and/or the target element 18 by modulating a current flowing into the heating element 14. The controller 26 may be, for example, a microcontroller.

Although not illustrated in FIG. 1a, the heating system 10 may include a switch that supplies current to the heating element 14, and the controller 26 may control the switch to modulate the current applied to the heating element 14. In various embodiments, the switch may be included in and/or be a part of the controller 26.

In various embodiments, the heating system 10 may also include a temperature sensor 22 thermally coupled (illustrated by dotted line 28) to the target element 18 and/or thermally coupled (illustrated by dotted line 32) to the heating element 14. The temperature sensor 22 may sense temperature of the target element 18 and/or the heating element 14, and provide a feedback (e.g., in the form of a current) to the controller 26. The temperature sensor 22 may be, for example, a thermistor, a resistance temperature detector (RTD), or any other appropriate type of temperature sensors known to those skilled in the art.

In various embodiments, the controller 26 may be coupled to an alternating current (AC) power supply and/or a direct current (DC) power supply (not illustrated in FIG. 1a) and receive input power 40. In various embodiments, the controller may receive input power 40 from the AC power supply; and in the event of a failure in the AC power supply, may receive input power 40 from the DC power supply. In various embodiments, the controller 26 may receive input power 40 from a DC power supply (e.g., a battery). The controller 26 may modulate the input power 40 and apply the modulated input power to the heating element 14, based at least in part on the output of the temperature sensor 22.

In various embodiments, the controller 26 may also receive one or more user configurable settings 44 and may modulate the power supply to the heating element based at least in part on the user configurable settings 44. Although not illustrated in FIG. 1a, in various embodiments, the controller 26 may receive the user configurable settings 44 through a programming interface included in or operatively coupled to the controller 26. The user configurable settings 44 may be, for example, a heating mode of the target element 18. For example, the target element 18 may be a garment and the user configurable settings 44 may include a heat setting of the garment 18. The heat setting may be based at least in part on a preference and/or a body condition of a user of the garment 18. For example, the garment 18 may be a thermal blanket or a thermal glove (e.g., a blanket or a glove that may be maintained at a substantially constant user configurable temperature or track a user configurable temperature profile). In various embodiments, a heat setting for the garment 18 may include a normal setting and/or a sensitive setting. An operation of the garment 18 at the sensitive setting may ensure a relatively finer temperature control of the garment 18 as compared to a normal setting. For example, a person with greater sensitivity to cold temperatures or temperature changes (e.g., someone with a vascular disorder such as Raynaud's disease) may prefer to use the garment 18 with the sensitive setting, instead of the normal setting.

Although not illustrated, in various embodiments, the controller 26 may be coupled to or may include a memory, which may be volatile and/or non-volatile memory that stores data that may relate to the operation of the heating system 10. The data may include temperature, current to the heating element 14, user configurable settings 44, etc.

In various embodiments, the lighting system 10 may also include a light emitting diode (LED) 50 coupled to a resistance 54. The controller 26 may control the indicator LED 50 in a manner to communicate information that may correspond to the operation of the heating system 10. For example, the indicator LED 50 may indicate that a temperature of the target element 18 is outside of a predetermined operating range, e.g., it is either above an upper predetermined threshold temperature or below a lower predetermined threshold temperature. In various embodiments, the indicator LED may also be illuminated whenever the heating element 14 may be conducting electricity. The indicator LED may also be illuminated to indicate a failure of the heating element 14 and/or one or more other components of the heating system 10.

FIG. 1b illustrates another exemplary heating system 80, in accordance with various embodiments of the current disclosure. In various embodiments, the heating system 80 of FIG. 1b may be at least in part similar to the heating system 10 of FIG. 1a. For example, heating element 14, temperature sensor 22, target element 18, LED 50, resistance 54, input 40, and/or used configurable settings 44 of FIGS. 1a and 1b may be at least partially similar. Also, similar to the controller 26 of FIG. 1a, the heating system 80 may include a controller 86 (e.g., a microprocessor) to control a switching device 60. In various embodiments, the controller 86 may control the switching device 60 based at least in part on the feedback from the temperature sensor 22 and/or user configurable settings 44, and the switching device 60 may in turn modulate the power supplied to the heating element 14.

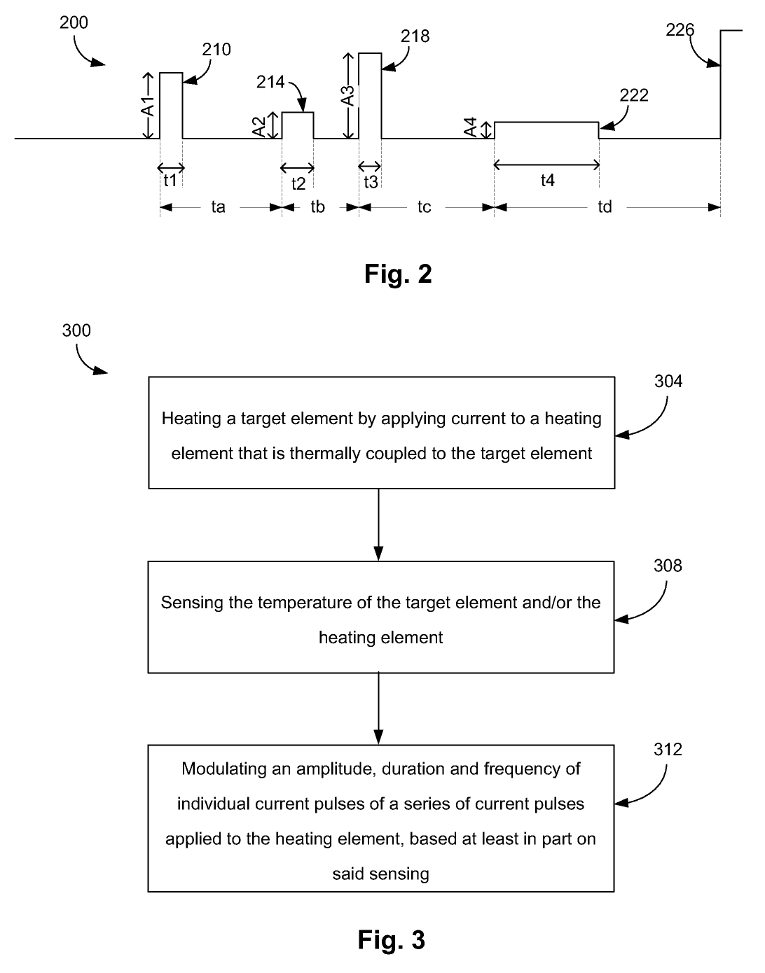

FIG. 2 illustrates an exemplary series of current pulses 200 applied to the heating element 14 of FIGS. 1a and 1b, in accordance with various embodiments of the current disclosure. In various embodiments, the controller 26 of FIG. 1a (or the controller 86 and the switching device 60 of FIG. 1b) may modulate the input power 40 to generate the series of current pulses 200 and apply the same to the heating element 14. In various embodiments, the series of current pulses 200 may be used to heat the heating element 14 such that the temperature of the target element 18 may track (e.g., be substantially equal to) a target temperature profile. The target temperature profile may be, for example, a constant temperature or may vary with time (e.g., gradually increase with a programmable gradient and then be constant).

In various embodiments, the series of current pulses 200 may include at least a first current pulse 210, a second current pulse 214, a third current pulse 218, a fourth current pulse 222, and a fifth current pulse 226. The number, amplitude, duration, frequency and/or time of individual current pulses illustrated in FIG. 2 are purely exemplary in nature. In various embodiments, individual current pulses in the series of current pulses 200 may be rectangular pulses. In FIG. 2, the amplitude of the first, second, third, and fourth current pulses are illustrated as A1, . . . , A4, respectively. For the purpose of this disclosure and unless otherwise stated, a duration of a current pulse may be a time between a start of the current pulse and an end of the current pulse. In FIG. 2, the duration of the first, second, third, and fourth current pulses are illustrated as t1, . . . , t4, respectively. In various embodiments, the time between the start of the first current pulse 210 and the start of the second current pulse 214 is identified as ta; the time between the start of the second current pulse 214 and the start of the third current pulse 218 is identified as tb; the time between the start of the third current pulse 218 and the start of the fourth current pulse 222 is identified as tc; and the time between the start of the fourth current pulse 222 and the start of the fifth current pulse 226 is identified as td. In various embodiments, a frequency of the current pulses may refer to how frequent the current pulses are applied. For example, the frequency of the second current pulse 214 may be inversely proportional to the time ta and/or tb.

In various embodiments, an amplitude, duration, and/or frequency of individual current pulses, and a time difference between start of any two consecutive current pulses may be modulated by the controller 26 (or the controller 86 and the switching device 60). In various embodiments, an amplitude, duration and/or frequency of one of the current pulses may be different and/or independent from that of another of the series of current pulses 200. In various embodiments, the amplitude, duration and/or frequency of individual current pulses of the series of current pulses may be different and/or independent.

For example, the amplitude (e.g., A1, . . . , A4) of individual current pulses may be independent of and/or different from other current pulses (e.g., A1 may not be equal to A2, A3 or A4). In various embodiments, the duration of time for which individual current pulses are applied (e.g., t1, . . . , t4) may be independent of and/or different from other current pulses (e.g., t1 may not be equal to t2, t3 and/or t4). The frequency of individual current pulses may be independent of and/or different from other current pulses (e.g., ta may not be equal to tb, tc and/or td).

In various embodiments, a time difference between start of any two consecutive current pulses (e.g., ta, . . . , td) may be different and/or independent for individual pairs of consecutive current pulses (e.g., ta may not be equal to tb, tc and/or td).

In various embodiments, by modulating the amplitude, duration, frequency, and/or time duration between start of two consecutive current pulses, the heating system 10 may have a better (e.g., finer) control of the temperature of the target element 18 and/or use a reduced amount of input power 40. For example, if a present temperature (measured, for example, by the temperature sensor 22) of the target element 18 is slightly less than a target temperature, then the controller 26 (or the controller 86) may modulate the current to the heating element such that a pulse of relatively less amplitude and/or relatively less duration is applied to the heating element 14. In various embodiments, the current pulses may depend on, for example, a difference in the temperature of the target element 18 and a target temperature, the present, historical and/or predicted rate at which this difference may change with time, etc. In various embodiments, the current pulses may also depend on the user configurable settings 44, including, for example, heat settings (e.g., normal setting, sensitive setting, etc.) of the target element 18.

In various embodiments, the current pulse may also be based at least in part on historical or past preference of a user of the target element 18. For example, a user of the target element 18 (e.g., a thermal glove) may initially (e.g., when the user's hand is cold and uncomfortable) set a target temperature at 80° Fahrenheit (F). As the glove starts warming, and reaches and stays at or near (e.g., between 78° F. and 82° F.) the target temperature for some time, the user's hand may also get warm (e.g., reach or be near the target temperature of 80° F.). Once the user feels comfortable for at least a certain duration of time (e.g., 5 minutes), the user may decrease the target temperature to, for example, 75° F. In various embodiments, controller 26 or controller 86 may identify this behavior or preference of the user, and in future may automatically decrease the target temperature (e.g., from 80° F. to 75° F.) once the actual temperature of the glove reaches the target temperature and stays at or near the target temperature for at least a certain duration of time (e.g., 5 minutes).

In various embodiments, a heating pattern (e.g., a pattern of the series of current pulses 200) may be based on various factors, including, for example, the rate at which the actual temperature changes with time. For example, if a user with a relatively colder hand (e.g., at around 30° F.) wears a thermal glove and sets a target temperature of 80° F., the actual temperature of the glove may start increasing and reach at or near the target temperature of 80° F. However, as the glove may be in contact with a relatively cold hand, the temperature of the glove may decrease at relatively high rate (or the rate of increase of temperature of the glove may be slow because of contact with a cold hand). In various embodiments, the controller of the glove may identify this, and may increase the rate at which the heat is provided to the heating element 14 (e.g., by providing a series of current pulses with higher frequency, longer duration and/or higher amplitude). Put differently, the controller 26 and/or 80 may identify a preference and/or a body condition (e.g., cold hand) of a user, and may adaptively update the heating pattern of the heating element 14 by modulating the series of current pulses 200 accordingly.

FIG. 3 is an exemplary method 300 for operating the heating systems of FIGS. 1a and 1b, in accordance with various embodiments of the current disclosure. In various embodiments, the method 300 may include, at block 304, heating the target element 18 by applying current to the heating element 14 that is thermally coupled to the target element 18. The method 300 may further include, at block 308, sensing the temperature of the target element 18 and/or the heating element 14 using, for example, the temperature sensor 22. The method 300 may further include, at block 312, modulating an amplitude, duration, frequency and/or time between start of two consecutive current pulses of the series of current pulses 200 applied to the heating element 14, based at least in part on the sensing at block 308.

In various embodiments, the series of current pulses may include at least a first and a second current pulse, and the modulating of block 312 may further comprise modulating the first and second current pulse such that duration of the first current pulse may be different from that of the second current pulse. In various embodiments, the series of current pulses may include at least a first and a second current pulse, and the modulating of block 312 may further comprise modulating the first and second current pulse such that amplitude of the first current pulse is different from that of the second current pulse. In various embodiments, the series of current pulses may include at least a first, second and third current pulse, wherein the first, second, and third current pulses may be three consecutive current pulses in the series of current pulses, and the modulating of block 312 may further comprise modulating the first and second current pulse such that a time between a start of the first current pulse and a start of the second current pulse is different from a time between the start of the second current pulse and a start of the third current pulse. In various embodiments, the modulating of block 312 may further comprise modulating the individual current pulses of the series of current pulses based at least in part on a heating mode of the systems of FIGS. 1a and 1b. In various embodiments, the heating mode may be a part of the user configurable settings 44, and may be received in the controller 24 (or controller 86) through a programming interface (not illustrated in FIGS. 1a and 1b) included in or operatively coupled to the controller 24 (or controller 86).

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present disclosure. Similarly, memory devices of the present disclosure may be employed in host devices having other architectures. This application is intended to cover any adaptations or variations of the embodiments discussed herein. Therefore, it is manifestly intended that embodiments in accordance with the present disclosure be limited only by the claims and the equivalents thereof.

What is claimed is:

1 . An apparatus comprising:
a heating element configured to heat a target element;
a temperature sensing device configured to be thermally coupled to the heating element or the target element to provide an output proportional to a temperature of the heating element or the target element to which the temperature sensing device is thermally coupled; and
a controller configured to modulate an amplitude, duration and frequency of individual current pulses of a series of current pulses applied to the heating element, based at least in part on the output of the temperature sensing device.

2. The apparatus of claim 1, wherein the series of current pulses includes at least a first and a second current pulse, and wherein a duration of the first current pulse is different from that of the second current pulse.

3. The apparatus of claim 1, wherein the series of current pulses includes at least a first and a second current pulse, and wherein an amplitude of the first current pulse is different from that of the second current pulse.

4. The apparatus of claim 1, wherein the series of current pulses includes at least a first, second, and third current pulse, wherein the first, second, and third current pulses are three consecutive current pulses in the series of current pulses, and wherein a time between a start of the first current pulse and a start of the second current pulse is different from a time between the start of the second current pulse and a start of the third current pulse.

5. The apparatus of claim 1, further comprising:
a switch to be controlled by the controller to modulate the individual current pulses.

6. The apparatus of claim 1, wherein the controller is further configured to modulate the individual current pulses such that a temperature of the target element tracks a target temperature.

7. The apparatus of claim 1, wherein the controller is configured to modulate the individual current pulses based at least in part on a heating mode of the apparatus.

8. The apparatus of claim 7, further comprising:
a programming interface configured to receive the heating mode from a user of the apparatus.

9. The apparatus of claim 1, wherein the apparatus is a garment.

10. A method comprising:
heating a target element by applying current to a heating element that is thermally coupled to the target element;
sensing the temperature of the target element or the heating element; and
modulating an amplitude, duration and frequency of individual current pulses of a series of current pulses applied to the heating element, based at least in part on said sensing.

11. The method of claim 10, wherein the series of current pulses includes at least a first and a second current pulse, and wherein said modulating further comprises:
modulating the first and second current pulse such that a duration of the first current pulse is different from that of the second current pulse.

12. The method of claim 10, wherein the series of current pulses includes at least a first and a second current pulse, and wherein said modulating further comprises:
modulating the first and second current pulse such that an amplitude of the first current pulse is different from that of the second current pulse.

13. The method of claim 10, wherein the series of current pulses includes at least a first, second and third current pulse, wherein the first, second, and third current pulses are three consecutive current pulses in the series of current pulses, and wherein said modulating further comprises:
modulating the first, second and third current pulse such that a time between a start of the first current pulse and a start of the second current pulse is different from a time between the start of the second current pulse and a start of the third current pulse.

14. The method of claim 10, wherein said modulating further comprises:
modulating the individual current pulses of the series of current pulses based at least in part on a heating mode.

15. An apparatus comprising:
means for applying current to a heating element that is thermally coupled to a target element;
means for sensing a temperature of the target element or the heating element; and
means for modulating an amplitude, duration and frequency of individual current pulses of a series of current pulses applied to the heating element, based at least in part on said means for sensing.

16. The apparatus of claim 15, wherein the series of current pulses includes at least a first and a second current pulse, and wherein said means for modulating further comprises:
means for modulating the first and second current pulse such that a duration of the first current pulse is different from that of the second current pulse.

17. The apparatus of claim 15, wherein the series of current pulses includes at least a first and a second current pulse, and wherein said means for modulating further comprises:
means for modulating the first and second current pulse such that an amplitude of the first current pulse is different from that of the second current pulse.

18. The apparatus of claim 15, wherein the series of current pulses includes at least a first, second and third current pulse, wherein the first, second, and third current pulses are three consecutive current pulses in the series of current pulses, and wherein said means for modulating further comprises:
means for modulating the first, second and third current pulse such that a time between a start of the first current pulse and a start of the second current pulse is different from a time between the start of the second current pulse and a start of the third current pulse.

19. The apparatus of claim 15, wherein said means for modulating further comprises:
means for modulating the individual current pulses of the series of current pulses based at least in part on a heating mode.

20. The apparatus of claim 15, further comprising:
means for inputting the heating mode.
